(19) United States
(12) Patent Application Publication
(10) Pub. No.: US 2010/0065636 A1
(43) Pub. Date: Mar. 18, 2010

(54) Ontology-Based EPC Automatic Conversion Method and System

(75) Inventors: Yung Cheol Byun, Cheju-City (KR); Sang Yeol Park, Cheju-City (KR); Young SiK Noh, Cheju-City (KR); Moon Seok Yang, Cheju-City (KR); Ji Woong Byun, Cheju-City (KR)

Correspondence Address: Grossman, Tucker, Perreault & Pfleger, PLLC, 55 South Commercial Street, Manchester, NH, 03101, US

(73) Assignee: JAVA INFORMATION TECHNOLOGY LTD., Cheju-City (KR)

(21) Appl. No.: 12/432,018

(22) Filed: Apr. 29, 2009

(30) Foreign Application Priority Data
Apr. 29, 2008 (KR) 1020080039901

(51) Int. Cl. G06K 7/00

(52) U.S. Cl. 235/435; 341/1

(57) ABSTRACT

Disclosed herein is an ontology-based Electronic Product Code (EPC) automatic conversion method and system. The ontology-based EPC automatic conversion method includes the steps of arranging existing Radio Frequency Identification (RFID) EPC ontology information and newly added EPC ontology information, converting tag data collected from an RFID reader into binary data so as to perform header information extraction and Uniform Resource Name (URN) conversion, extracting the header information of an EPC from the binary data output as a result of the conversion, initializing the ontology properties so as to utilize the EPC ontology, extracting a corresponding code system of the ontology by performing comparison with the header information of the tag data converted into the binary data, extracting the ontology properties from the corresponding code system of the ontology, and performing automatic conversion into URN-type data on the basis of information about the extracted ontology properties.

### BACKGROUND OF THE INVENTION

1. Field of the Invention

The present invention relates generally to an ontology-based Electronic Product Code (EPC) automatic conversion method and system, and, more particularly, to a method and system for automatically converting various types of Radio Frequency Identification (RFID) EPC data collected from RFID readers into Uniform Resource Name (URN) data, which can be efficiently processed inside RFID middleware based on the ALE standard specification of EPCglobal, in the middleware.

2. Description of the Related Art

RFID technology is non-contact type data acquisition technology. RFID technology, together with context awareness technology, is considered to be one of the technologies required for the implementation of ubiquitous computing. Furthermore, research and development into RFID middleware that functions as a bridge to enable application service developers to easily construct ubiquitous applications using RFID technology by performing the collection, processing and transfer of data and the control and management of devices is being conducted.

Actually, EPCglobal Class 1 Gen. 2 that was proposed by EPCglobal which is the leader in international standards of RFID technology is not only the actual standard in the 900 MHz band, but was also adopted as an international standard under the title of ISO 18000-6C. Furthermore, EPCglobal presented a proposal for an EPC network standard, and many companies which have developed or will develop RFID middleware platforms have adopted the proposal.

With regard to the EPC network, for RFID middleware, implementation-oriented Savant Version 0.1 was proposed in 2002, Savant Version 1.0 was proposed in 2003, and interface-oriented Application Level Event (ALE) was proposed in 2004. Meanwhile, ALE is middleware that performs the functions of filtering and collecting EPC information. Additionally, the air interface between readers and tags, EPC-IS, EPC Discovery Service and ONS are provided as the components of a basic architecture.

When EPC data is input from a reader, RFID middleware internally converts the EPC data into URN-type data, performs filtering and grouping using the URN-type data, and transmits results to an application. Meanwhile, EPC data may be of various types, and new types of EPC may appear in the future. Accordingly, a method in which RFID middleware efficiently process various types of EPC data is required.

EPCglobal defines a set of technologies that is required for the construction of EPC-based ‘Internet of Physical Objects’, that is, the unique identifiers of individual objects, as the EPC network. The components thereof include a reader protocol for the exchange of information between readers and tags, a standard function list definition for reader control and management, filtering and collection for the definition of a standard specification required for data representation and information provision necessary to the acquisition of filtered and summarized data from recognized tag information, ALE for the definition of external interfaces, and EPCIS for the definition of external interfaces for acquiring, managing and sharing EPC-related information.

Furthermore, the establishment of a standard is being performed in the security field which requires the definition of a kind of guideline to be used for defining a specification required for the representation of ONS and EPC encoding/decoding rules for providing EPC-related EPCIS location information search service and the performance of EPC conversion work on the basis of the rules and for providing a security framework over the overall EPC network for tag data conversion, user information protection and data encryption.

Although the architecture proposed by EPCglobal has a structure systematic for the management of RFID data, it does not describe a method of efficiently processing new types of EPC tag data as well as existing various types of EPC tag data during the management of tag data exchanged between RFID tags and RFID readers.

Furthermore, EPCglobal proposed Class 0, Class 1, generation1 and generation2 in the documents of EPC tag data specification version 1.24, version 1.27 and version 1.3 corresponding to tag data. It is expected that in the future, additional types of developed code will be continuously proposed in line with the developing RFID industry.

With regard to basic codes, the General Identifier (GID) code system is an identification system that was newly and independently defined regardless of any existing identification system or standard, and the Serialized Global Trade Identification Number (SGTIN) code system is a code system that was proposed to assign unique identifiers to individual objects on the basis of the Global Trade Item Number (GTIN) code proposed by EAN.UCC.

The Serial Shipping Container Code (SSCC) system was proposed to identify the delivery units (for example, boxes, pallets, containers, etc.) used by manufacturers, logistics providers or goods suppliers to deliver products to companies which ordered them. The Serialized Global Location Number (SGLN) code system can support only the current physical locations of Global Location Numbers (GLNs). It can represent not only individual units, such as individual slots, but also collective units, such as warehouses. The Global Returnable Asset Identifier (GRAI) code system is used to manage returnable assets. The returnable assets refer to transport equipment or reusable objects. That is, they refer to objects or vehicles that may be used during transportation and trade, such as pallets, barrels, gas cylinders, beer barrels, railroad train cars, etc.

The Global Individual Asset Identifier (GIAI) code system is used to identify the fixed assets of an organization. The fixed assets refer to assets that are not consumed in trade or business. The DoD code system is a code system that was defined by the U.S. Department of Defense to classify materials arriving at subordinate military units into separate goods, pallets and cases, attach RFID tags thereto and identify them. The DoD code system is characterized in that it uses Commercial and Government Entity (CAGE) codes. The DoD code system is used to identify material suppliers through the input of CAGE codes and guarantee the uniqueness of serial numbers used by the material suppliers.

A general type of RFID EPC is GID-96, and the EAN.UCC system identification types include SGTIN-64, 96 and 198, SSCC-64 and 96, and SGLN-64, 96 and 195. Furthermore, there are GRAI-64, 96 and 170, GIAI-64, 96 and 202, and DoD-64 and 96. FIG. 1 is a diagram showing the structure of fields that constitute such an RFID EPC system.

The ALE-based RFID middleware receives hexadecimal source code data, such as 8000000040010000, from an RFID reader, extracts a field value based on a field structure, and performs conversion into a URN code having a format, such as urn:epc:tag:sgtin-64:0.0.32.65536. The URN code data is processed based on filtering and grouping conditions described in the specification, the results of the processing are converted into a report, and the report is transmitted to various ubiquitous applications.

In general, the ALE-based RFID middleware has the following requirements. First, the RFID middleware should guarantee interoperability of various types of reader interfaces, various types of code and network interworking, and various application platforms. The middleware that guarantees interoperability is referred to as open middleware. Second, for this, standardized code, information representation and exchange protocol should be observed, and messaging technology for performing information exchange should be used. Third, to meet the above requirements, reference representation, such as the EPC specification, the ISO standard and web service, should be applied, and the design and implementation of an integrated interface that supports a multi-reader protocol (EPC, ISO 15961, and Alien) is required.

In the filtering management techniques of previously developed RFID middleware, context definition and processing are performed through the design and application of predefined filters based on independent technologies. Currently, the research and development into middleware based on the ALE specification of EPCglobal is being conducted. Table 1 summarizes the functions of previously implemented middleware.

TABLE 1
Comparison of RFID middleware

| | | Sun Java System | Oracle Edge Server/ | |
|---|---|---|---|---|
| Classification | OAT System | RFID Software | Sensor Data Hub | CARU |
| Supported | Matrics, Alien, | Alien, Matrics, | Alien, Intermec, | Alien, Intermec |
| readers | ThingMagic, | Sensormatic, | Lightstick | (PDA-type), Matrics, |
| | SAMSys, AWID | ThingMagic | | Korean B company |
| Data format | EPC | EPC | EPC | EPC |
| Context | predefined | predefined | predefined | predefined |
| processing | filter | filter | filter | filter |
| Enterprise | XML via File, | File, JMS, | Stream, JMS, Web | HTTP, JMS, |
| interworking | JMS, http | XML/HTTP/SOAP | Service, Http Post | SOAP, XML |

With regard to the support of various types of RFID EPC tag data, most types of currently existing RFID middleware M support part of the entire code system, including EPC Gen1, Gen2, etc., proposed by EPCglobal. Furthermore, since supported EPC is managed in subordination to the existing middleware, the existing middleware is not efficient in being extended so as to be able to process various newly defined types of RFID EPC tag data. Furthermore, due to the problem with the implementation of the existing RFID middleware, although a system is constructed using a component or object-oriented technique, it is difficult to perform maintenance because the work of changing functions and the work of making additions require a long time and a lot of effort due to cross-cutting concerns existing in the code.

On the basis of the above-described content and problems of the existing related researches and technologies, items to be considered in the present invention will now be described. First, the standard should be observed on the basis of the EPC tag data conversion rules of EPCglobal. Second, a common method capable of converting flexible and various types of EPC is required. That is, all of currently proposed EPC systems should be processed. Third, the method of the present invention should be an extensible EPC tag data conversion method. That is, in the future, the RFID-based ubiquitous computing environment is continuously developing, with the result that new types of RFID EPC tag data may be proposed. Accordingly, the method of the present invention should be easily extended to efficiently process newly added data formats.

### SUMMARY OF THE INVENTION

Accordingly, the present invention has been made keeping in mind the above problems occurring in the prior art, and an object of the present invention is to provide an ontology-based method and system that is capable of efficiently processing newly defined EPC data as well as currently existing EPC data inside RFID middleware based on the ALE standard specification of EPCglobal when automatically converting various types of RFID EPC data collected from RFID readers into URN-type data that can be efficiently processed in the middleware.

In order to accomplish the above object, the present invention provides an ontology-based EPC automatic conversion method, including the steps of constructing existing Radio Frequency Identification (RFID) EPC ontology information and newly added EPC ontology information; converting tag data collected from an RFID reader into binary data so as to perform header information extraction and Uniform Resource Name (URN) conversion; extracting header information of an EPC from the binary data output as a result of the conversion; initializing ontology properties so as to utilize the EPC ontology; extracting a corresponding code system of the ontology by performing comparison with the header information of the tag data converted into the binary data; extracting ontology properties from the corresponding code system of the ontology; and performing automatic conversion into URN-type data on the basis of information about the extracted ontology properties.

The EPC automatic conversion method may further include the step of, if the tag data collected from the REID reader is of an ISO type or a barcode type, creating an ISO class or a barcode class and constructing the EPC ontology information using the ISO class or barcode class.

The step of extracting ontology properties from the corresponding code system of the ontology may include the steps of extracting additional class properties; extracting body class properties; extracting fragment class properties; creating fragment processing information; and dividing the binary data by a number of pieces of extracted fragment processing information on the basis of start and end locations values of corresponding fragments.

The step of extracting ontology properties from the corresponding code system of the ontology may further include the step of extracting partition class properties.

The step of extracting ontology properties from the corresponding code system of the ontology may further include the step of eliminating a word boundary property value of the body class from the binary data.

The step of initializing the ontology properties so as to utilize the EPC ontology may include the steps of creating ontology object properties; and creating ontology data type properties.

In order to accomplish the above object, the present invention provides an ontology-based EPC automatic conversion apparatus, including a reader interface processing unit for collecting various types of RFID tag data; a logical reader processing unit for logically managing data of various physical RFID readers; an EPC listener processing unit for collecting EPC data from the collected RFID tag data on the basis of XML technology; an EPC extraction unit for extracting an EPC from the collected EPC data; and an EPC ontology manager processing unit for analyzing the extracted EPC, performing comparison with EPC ontology metadata and performing automatic conversion into a URN code that can be processed inside RFID middleware.

The EPC ontology manager processing unit may include a class creation unit for creating and initializing ontology object properties, ontology data type properties and class information, which connect properties of ontology classes, so as to perform EPC conversion; a class/property extraction unit for extracting property information of a Class class having Header property information in the ontology; a header information comparison unit for comparing the CodeHeader property information of the Class class with header information of the tag data converted into the binary data; a code system extraction unit for extracting a corresponding code system of the ontology; a code conversion information unit for extracting a plurality of classes/properties and constructing code conversion information; and a URN code conversion unit for creating a URN code by converting substantial information of the EPC separated based on code conversion information into the URN code.

The ontology classes may include an EPC class, a Code class, a Class class, an Additional class, a Body class, a Fragment class and a Partition class.

The EPC class may divide subClassof according to class relation, and the Additional class, Class class, Body class, Fragment class and Partition class comprise hasAdditional, hasClass, hasBody, hasFragment and hasPartition, respectively, as their object properties.

The Additional class may include CodeName, CodeMember, CodeSize and CodeURN as its data type properties; the Class class may include CodeHeader and CodeEncode as its data type properties; the Body class may include BodyCount, PartitionCount and WordBoundary as its data type properties; the Fragment class may include FragmentName, FragmentProcess, StartLocation and EndLocation as its data type properties; and the Partition class may include Value, FirstBit and SecondBit as its property data type properties.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the structure of fields that constitute an RFID EPC system;

FIG. 2 is a block diagram showing an ontology-based EPC automatic conversion system according to an embodiment of the present invention;

FIG. 3 is a diagram showing the detailed construction of the ontology manager processing unit of the ontology-based EPC automatic conversion system according to the present invention;

FIG. 4 is a block diagram showing the structure of an ontology for EPC conversion in the ontology-based EPC automatic conversion system of the present invention;

FIG. 5 is a diagram showing descriptions of the structure of the ontology for EPC conversion;

FIG. 6 is a diagram showing the rule syntax for EPC conversion;

FIG. 7 is a block diagram of URN code conversion;

FIG. 8 is a block diagram of EPC data conversion;

FIG. 9 is a diagram showing an example of the results of SGTIN-64 EPC conversion according to the present invention;

FIG. 10 is a diagram showing an example of the results of SGTIN-96 EPC conversion according to the present invention; and

FIG. 11 is a diagram showing an example of the results of SGTIN-198 EPC conversion according to the present invention.

### DESCRIPTION OF THE PREFERRED EMBODIMENTS

Reference now should be made to the drawings, in which the same reference numerals are used throughout the different drawings to designate the same or similar components.

A method and system for processing tag data in RFID middleware according to embodiments of the present invention will be described below with reference to the attached block diagrams and flowcharts. Here, it can be understood that respective blocks of the flowcharts and/or combinations of the blocks of the flowcharts may be performed by computer program instructions. Since it is possible to install these computer program instructions on a general-purpose computer, a special computer or some other processor of a programmable data processing device, the instructions executed through the computer or the processor of the programmable data processing device generate means for performing functions that are described in the blocks of the flowcharts. Furthermore, since it is possible to store these computer program instructions in computer-usable or computer-readable memory that can be oriented to a computer or some other programmable data processing device in order to implement functions in a specific manner, it is possible to manufacture products in which instructions stored in computer-usable or computer-readable memory include means for performing functions described in the blocks of flowcharts. Moreover, since it is possible to install computer program instructions on a computer or some other programmable data processing device, instructions for performing a series of operational steps on the computer or the programmable data processing device, generating processes executed by the computer and operating the computer or the programmable data processing device can provide steps for performing functions described in the blocks of flowcharts.

Furthermore, each block may refer to part of a module, a segment or code including one or more executable instructions for performing one or more specific logical functions. Moreover, it should be noted that in some alternative embodiments, functions described in blocks may occur out of order. For example, two successive blocks may be actually performed at the same time, or sometimes may be performed in reverse order according to relevant functions.

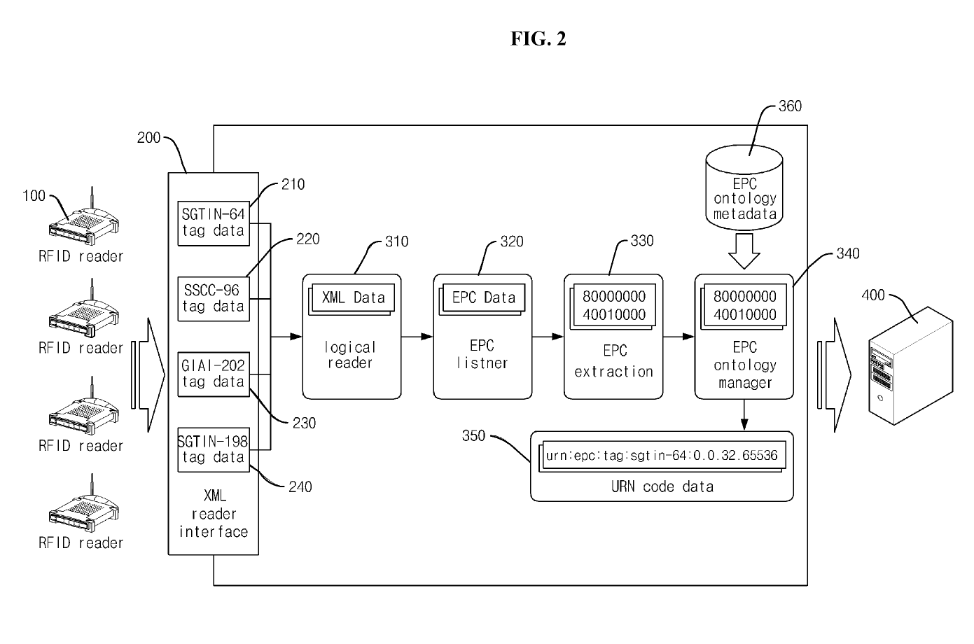

FIG. 2 is a block diagram showing an ontology-based EPC automatic conversion system 300 according to an embodiment of the present invention.

Referring to FIG. 2, the ontology-based EPC automatic conversion system 300 receives various types of RFID EPC data, including SGTIN-64 tag data 210, SSCC-96 tag data 220, GIAI-202 tag data 230 and SGTIN-198 tag data 240, from a plurality of RFID readers 100, converts the RFID EPC data into URN code data 350 using ontology metadata 360 for data conversion, and provides the URN code data 350 to RFID middleware 400 according to the ALE standard specification.

In more detail, the ontology-based EPC automatic conversion system 300 includes a reader interface processing unit 200 for collecting various types of RFID tag data, a logical reader processing unit 310 for logically managing the data of various physical RFID readers, an EPC listener processing unit 320 for collecting EPC data from the collected RFID tag data on the basis of XML technology, an EPC extraction unit 330 for extracting an EPC from the EPC data, and an EPC ontology manager processing unit 340 for analyzing the extracted EPC, comparing it with the EPC ontology metadata, and automatically converting it into URN code that can be processed inside the RFID middleware.

Here, reference numeral 360 denotes EPC ontology metadata constructed in the form of a DB.

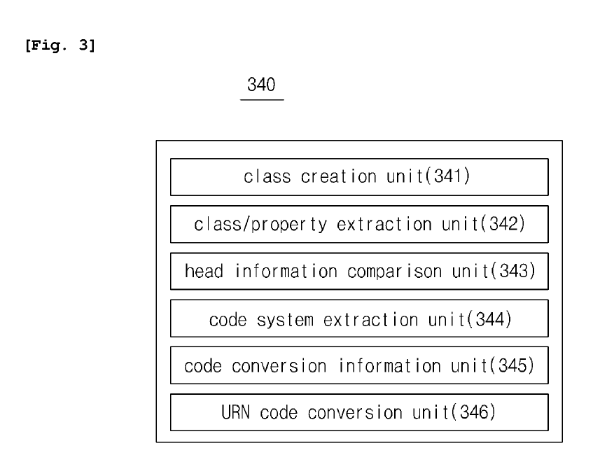

FIG. 3 is a diagram showing the detailed construction of the EPC ontology manager processing unit 340.

Referring to FIG. 3, the EPC ontology manager processing unit 340 includes a class creation unit 341 for creating and initializing ontology object properties, ontology data type properties and class information, which connect properties of ontology classes, so as to perform EPC conversion, a class/property extraction unit 34 for extracting the property information of a Class class having header property information in the ontology, a header information comparison unit 343 for comparing the CodeHeader property information of the Class class with the header information of tag data converted into binary data, a code system extraction unit 344 for extracting a corresponding code system of the ontology, a code conversion information unit 345 for extracting a plurality of classes/properties and constructing code conversion information, and a URN code conversion unit 346 for creating a URN code by converting substantial information of the EPC separated based on code conversion information into the URN code.

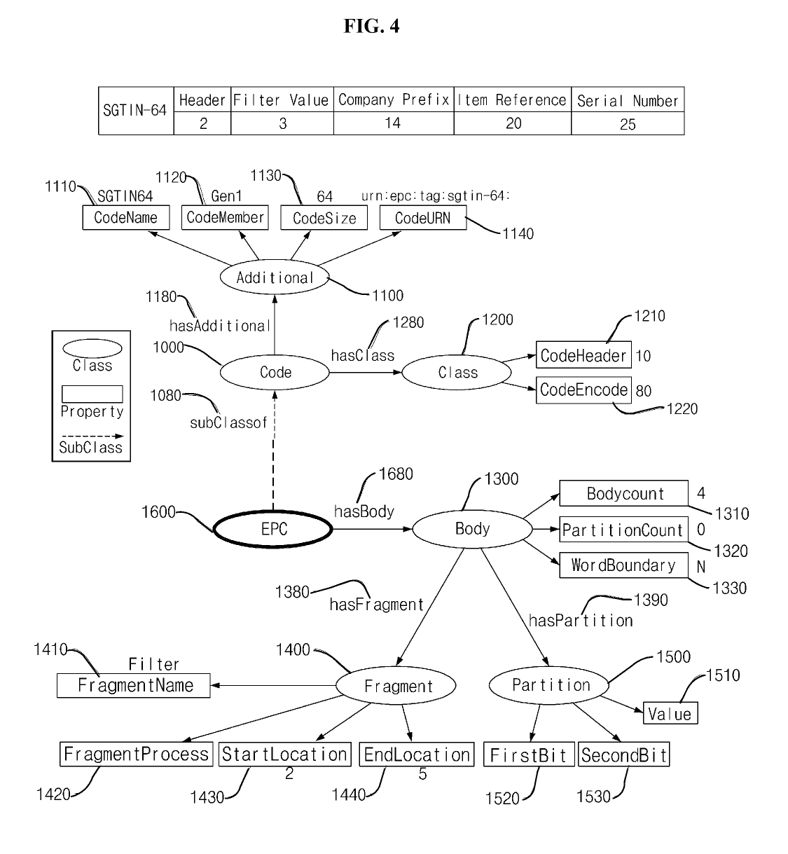

FIG. 4 is a block diagram showing the structure of an ontology for EPC conversion.

FIG. 4 shows a design of the ontology for automatic code conversion. In order to accommodate all of the ISO international standard code, the EPC of EPCglobal and barcodes currently and widely being used, an EPC class 1600 is defined as a subclass of a Code class 1000 and related properties are defined. Furthermore, in order to convert each code into a general-purpose URN code, a Body class 1300, a Fragment class 1400, a Partition class 1500 and properties required for code conversion have been designed.

With regard to the ontology structure, the Code class 1000 has an Additional class 1100 for managing a code URN information property 1140 corresponding to the front portion of a URN code, such as urn:epc:tag:sgtin-64, in urn:epc:tag:sgtin-64:0.0.32.65536, a code name property 1110, a code member information property 1120, such as Gen1 and Gen2 in the case of EPC information, and a code size information property 1130, and has a hasAdditional object property 1180 for managing the Additional class 1100.

Furthermore, the Code class 1000 has a Class class 1200 for managing the properties of code header information 1210 and code encoding information 1220 which are used to extract corresponding code information from code ontology information that is constructed based on the header information of source hexadecimal information, such as 8000000040010000, collected from an RFID reader, and the Class class 1200 is managed using a hasClass object property 1280. Furthermore, there are included a Body class 1300 for managing an RFID EPC structure information property, such as 0.0.32.65536, corresponding to the rear portion of a URN code, a Fragment class 1400 for managing each piece of structure classification information, and a Partition class 1500 for managing partition information used to convert an EPC Gen2 code into a URN code.

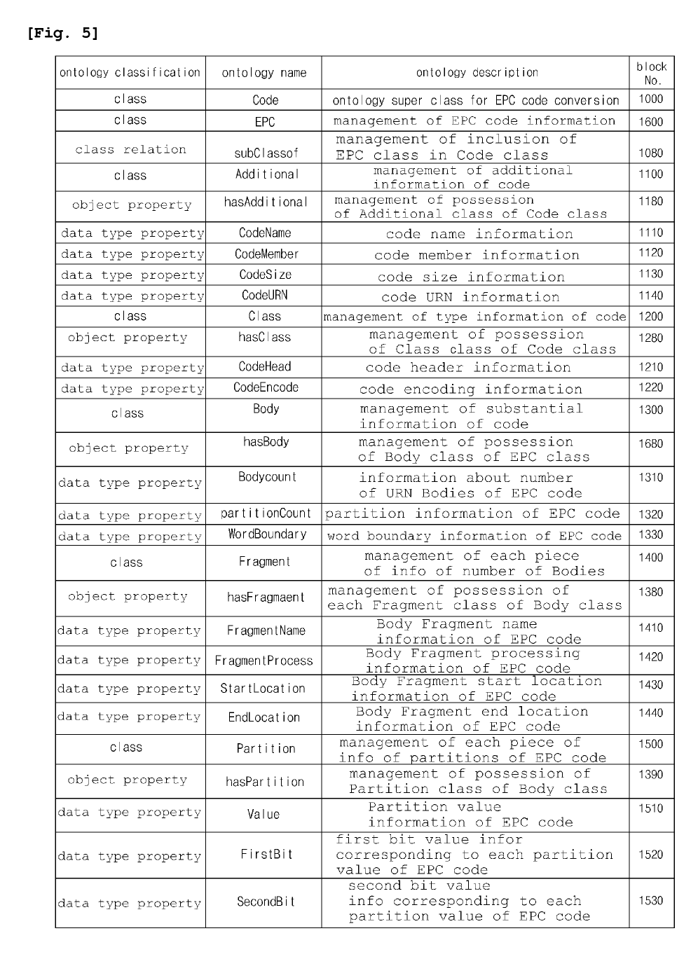

Furthermore, FIG. 5 shows a summary of descriptions of the structure of the ontology for EPC conversion.

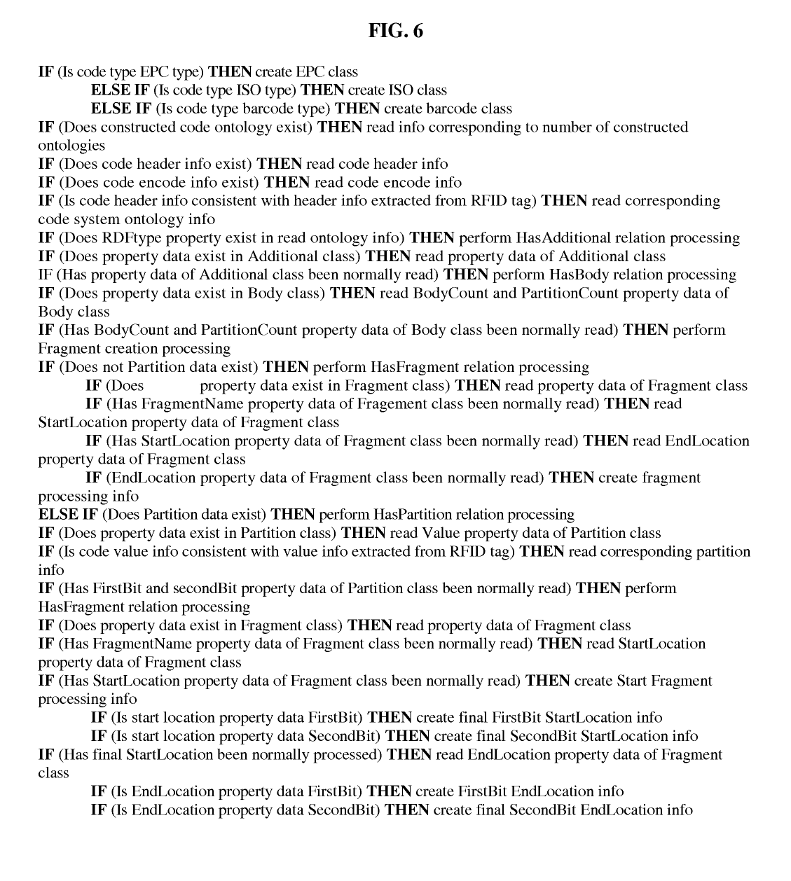

FIG. 6 shows the rule syntax for EPC conversion.

The rule syntax is prepared to provide rules for converting tag data collected from an RFID reader into a general-purpose URN code. In more detail, the rule syntax provides rules for performing conversion using ontology information in order to convert hexadecimal EPC data collected from an RFID reader into a general-purpose URN code on the basis of the ontology for EPC conversion shown in FIG. 4 in the EPC ontology manager 340 of the ontology-based EPC automatic conversion system shown in FIG. 2.

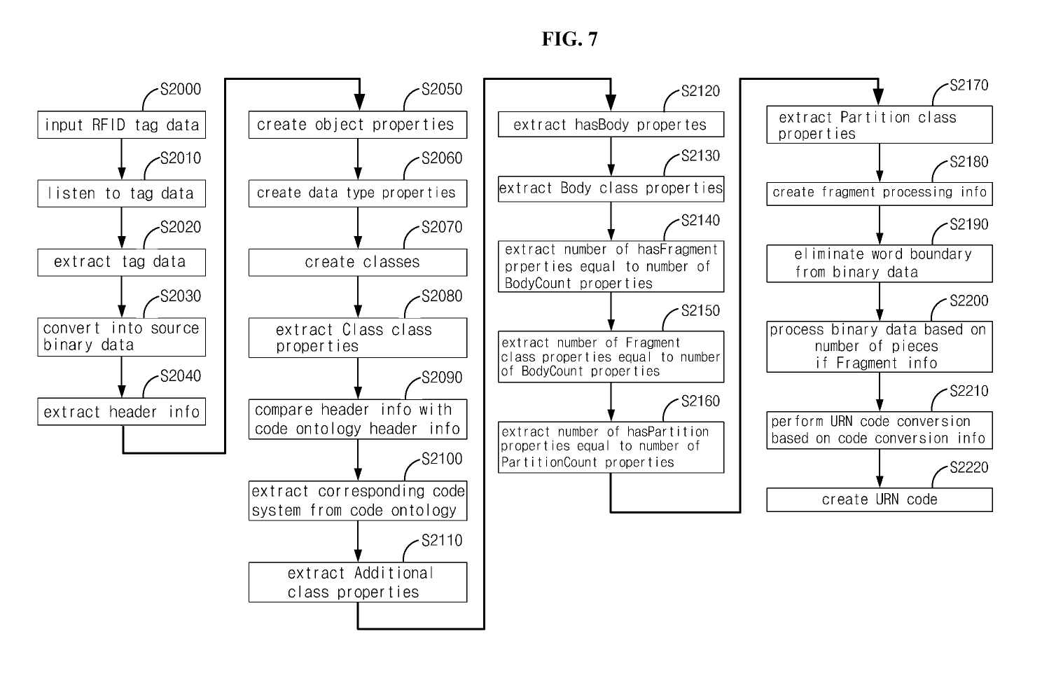

FIG. 7 is a block diagram of URN code conversion.

FIG. 7 is a block diagram showing a process of converting EPC data into a URN code on the basis of code conversion information constructed in the form of a code ontology.

With reference to FIG. 7, a detailed description will now be given. When RFID tag data is input from an RFID reader at step S2000, the input tag data is listened to at step S2010, and the tag data is extracted at step S2020. Thereafter, the tag data collected from the RFID reader is converted into binary data so as to perform URN conversion at step S2030, header information is extracted at step S2040, and ontology object properties, that is, relation information that connects ontology classes and properties with each other, ontology data type properties corresponding to property information, and each class information, that is, information used to perform the EPC conversion of FIG. 4, are respectively created and initialized at steps S2050, S2070 and S2060.

Thereafter, the property information of a Class class having header property information in the ontology is extracted at step S2080, the CodeHeader property information of the Class class is compared with the header information of the tag data converted into the binary data at step S2090, the corresponding code system of the ontology is extracted at step S2100, and Addition class properties are extracted from the extracted code system at step S2110. Thereafter, hasBody properties are extracted at step S2120, corresponding Body class properties are extracted at step S2130, a number of hasFragment properties equal to the number of BodyCount properties of the Body class are extracted at step S2140, and corresponding Fragment class properties are extracted at step S2150.

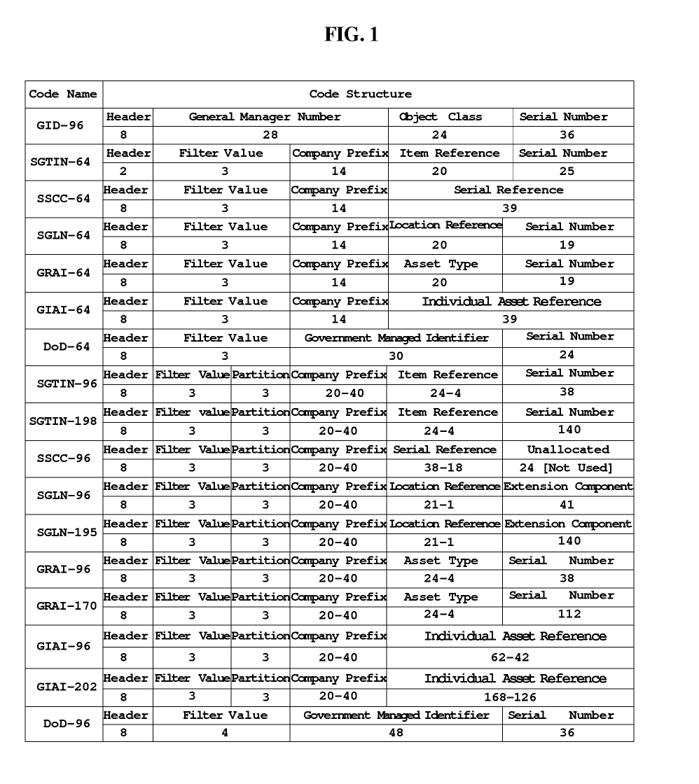

Thereafter, in the case where Partition information exists as in the SGTIN-96 code of FIG. 1, a number of hasPartition properties equal to the number of PartitionCount properties of the Body class are extracted at step S2160, corresponding Partition class properties are extracted at step S2170, and the fragment processing information of the corresponding EPC is created by calculating the location information and Partition information of the previously extracted fragment information at step S2180.

However, in the case where Partition information does not exist as in SGTIN-64 code, Partition information-related processing S2160 and S2170 is not performed.

Thereafter, SGTIN-198 code, SGLN-195 code, GRAI-170 code and GIAI-202 require the work of eliminating the word boundary property value of the Body class from the binary data in addition to the work of other EPCs at step S2190. The word boundary property value for SGTIN-198 code is “0000000000”, the word boundary property value for SGLN-195 code is “0000000000000”, the word boundary property value for GRAI-170 code is “000000”, and the word boundary property value for GIAI-202 code is “000000”. The work boundary value is used to deal with a digit problem that occurs when hexadecimal tag data collected from a reader is converted into binary data and then into a general-purpose URN code.

Thereafter, the process of dividing the binary data by the number of pieces of extracted fragment information (refer to S2180) on the basis of corresponding fragment start and end location values is performed at step S2200. Finally, the substantial information of the EPC separated on the basis of code conversion information is converted into a URN code at step S2210, and a resulting URN code is created by adding the code URN information 1140 of the Addition class 1100 and the URN code output as a result of the conversion at step S2220.

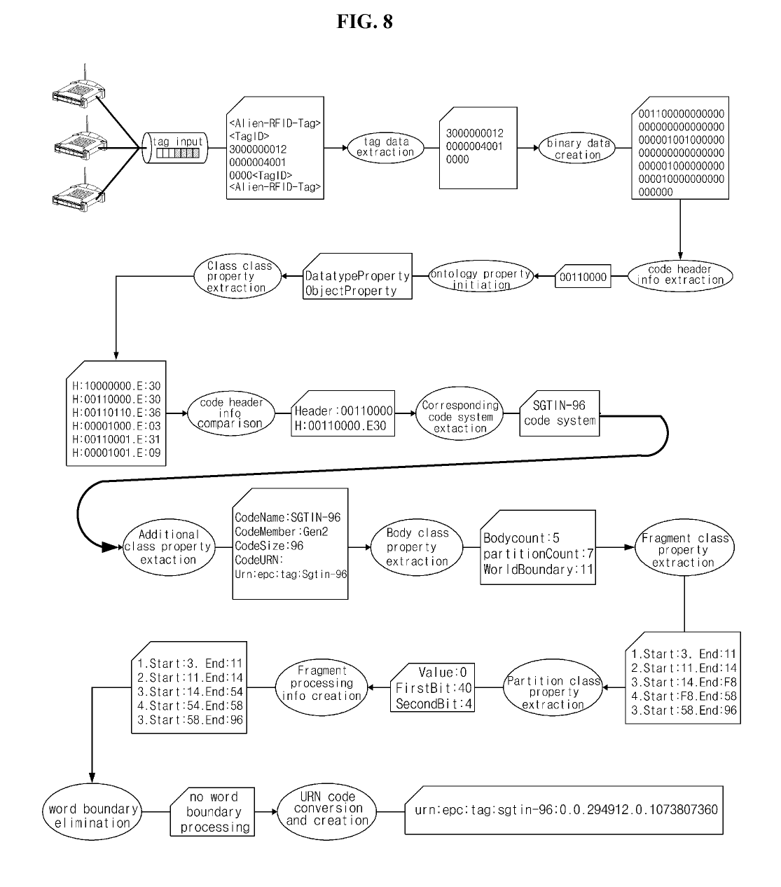

FIG. 8 is a block diagram of EPC data conversion.

In more detail, this drawing shows the data-centric process of, when the RFID tag data “300000001200000040010000” is input to the ontology-based EPC automatic conversion system 300, converting the RFID tag data into the general-purpose URN code “urn:epc:tag:sgtin-96:0.0.294912.0.1073807360” in line with the URN code conversion processing flow of FIG. 6 while applying the rules for the EPC conversion shown in FIG. 5.

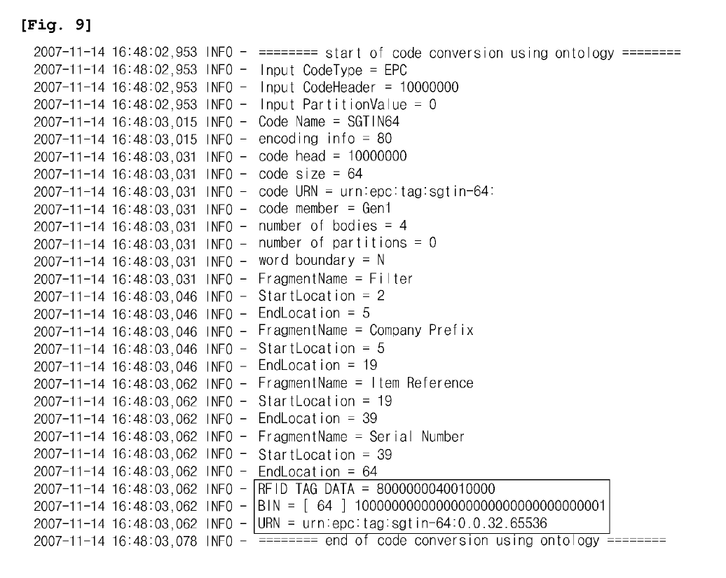

FIG. 9 is a diagram showing an example of the results of SGTIN-64 EPC conversion according to the present invention.

This drawing shows the log of a process in which when the data 8000000040010000 which is a code of EPC Class1 Generation1 which is encoded in SGTIN-64 form is input to the ontology-based EPC automatic conversion system, the fragment information of FIG. 1 is extracted on the basis of the header information of the data, and the general-purpose URN code urn:epc:tag:sgtin-64:0.0.32.65536 is created using the tag data converted into the binary data using the values on the basis of StartLocation and EndLocation values constructed in EPC ontology form.

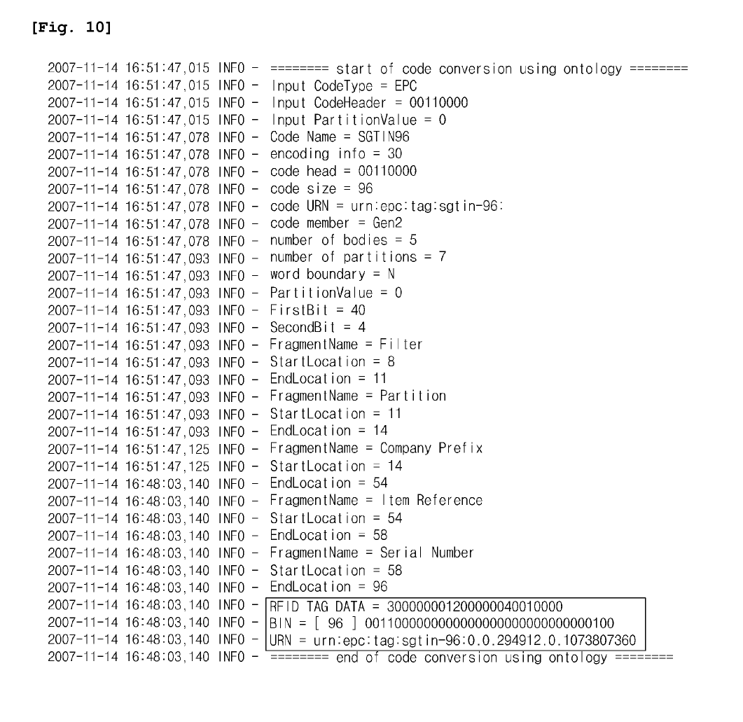

FIG. 10 is a diagram showing an example of the results of SGTIN-96 EPC conversion according to the present invention.

This drawing shows the log of a process of generating a general-purpose URN code using the ontology-based EPC automatic conversion system on the basis of the SGTIN-96 code of the EPC Class1 Generation2. When the tag data ‘300000001200000040010000 ’ is input using SGTIN-96 tag data, the header information ‘00110000 ’ is extracted, and conversion into the URN code ‘urn:epc:tag:sgtin-96:0.0.294912.0.1073807360 ’ is performed.

Although the format of the SGTIN-96 code is similar to that of the SGTIN-64 code of FIG. 8, the SGTIN-96 code includes partition information, unlike the SGTIN-64 code, as shown in FIG. 1, with the result that the information of the Company Prefix and Item Reference varies. Accordingly, the PartitionValue information ‘0 ’ is extracted, and the information ‘Company Prefix=40, Item Reference=4’ is additionally created.

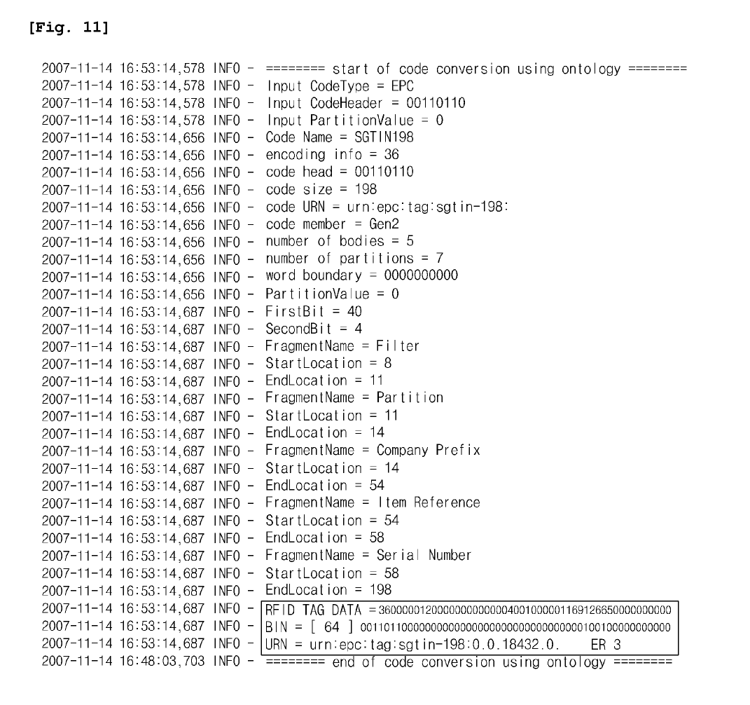

FIG. 11 is a diagram showing an example of the results of SGTIN-198 EPC conversion according to the present invention.

This drawing shows the log of a process of creating general-purpose URN code using the ontology-based EPC automatic conversion system on the basis of the SGTIN-198 code of the EPC Class1 Generation2. When the tag data ‘3600000001200000000000004001000001169126650000000000 ’ is input using SGTIN-198 tag data, the header ‘00110110 ’ is extracted, the general-purpose URN code ‘urn:epc:tag:sgtin-198:0.0.18432.0.ER3 ’ is generated.

The SGTIN-198 code is processed similarly to the SGTIN-96 code, but the SGTIN-198 code is additionally subjected to word boundary processing. A word boundary is information that is required for the conversion of hexadecimal data, encoded in a tag, into binary data. Furthermore, serial number information, which is the information of the last fragment of the URN code, is represented using a 7 bit ASCII code, unlike the case where it is represented using a decimal number in the SGTIN-64 code and the SGTIN-96 code.

As described above, the ontology-based method and system according to the present invention have the advantage of efficiently processing newly defined EPC data as well as currently existing EPC data inside RFID middleware based on the ALE standard specification of EPCglobal when automatically converting various types of RFID EPC data collected from RFID readers into URN-type data that can be efficiently processed in the middleware.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An ontology-based Electronic Product Code (EPC) automatic conversion method, comprising the steps of:
constructing existing Radio Frequency Identification (RFID) EPC ontology information and newly added EPC ontology information;
converting tag data collected from an RFID reader into binary data so as to perform header information extraction and Uniform Resource Name (URN) conversion;
extracting header information of an EPC from the binary data output as a result of the conversion;
initializing ontology properties so as to utilize the EPC ontology;
extracting a corresponding code system of the ontology by performing comparison with the header information of the tag data converted into the binary data;
extracting ontology properties from the corresponding code system of the ontology; and
performing automatic conversion into URN-type data on the basis of information about the extracted ontology properties.

2. The EPC automatic conversion method as set forth in claim 1, further comprising the step of, if the tag data collected from the RFID reader is of an ISO type or a barcode type, creating an ISO class or a barcode class and constructing the EPC ontology information using the ISO class or barcode class.

3. The EPC automatic conversion method as set forth in claim 1, wherein the step of extracting ontology properties from the corresponding code system of the ontology comprises the steps of:
extracting additional class properties;
extracting body class properties;
extracting fragment class properties;
creating fragment processing information; and
dividing the binary data by a number of pieces of extracted fragment processing information on the basis of start and end locations values of corresponding fragments.

4. The EPC automatic conversion method as set forth in claim 3, wherein the step of extracting ontology properties from the corresponding code system of the ontology further comprises the step of extracting partition class properties.

5. The EPC automatic conversion method as set forth in claim 3, wherein the step of extracting ontology properties from the corresponding code system of the ontology further comprises the step of eliminating a word boundary property value of the body class from the binary data.

6. The EPC automatic conversion method as set forth in claim 1, wherein the step of initializing the ontology properties so as to utilize the EPC ontology comprises the steps of:
creating ontology object properties; and
creating ontology data type properties.

7. An ontology-based EPC automatic conversion apparatus, comprising:
a reader interface processing unit for collecting various types of RFID tag data;
a logical reader processing unit for logically managing data of various physical RFID readers;
an EPC listener processing unit for collecting EPC data from the collected RFID tag data on the basis of XML technology;
an EPC extraction unit for extracting an EPC from the collected EPC data; and
an EPC ontology manager processing unit for analyzing the extracted EPC, performing comparison with EPC ontology metadata and performing automatic conversion into a URN code that can be processed inside RFID middleware.

8. The ontology-based EPC automatic conversion apparatus as set forth in claim 7, wherein the EPC ontology manager processing unit comprises:
a class creation unit for creating and initializing ontology object properties, ontology data type properties and class information, which connect properties of ontology classes, so as to perform EPC conversion;
a class/property extraction unit for extracting property information of a Class class having Header property information in the ontology;
a header information comparison unit for comparing the CodeHeader property information of the Class class with header information of the tag data converted into the binary data;
a code system extraction unit for extracting a corresponding code system of the ontology;
a code conversion information unit for extracting a plurality of classes/properties and constructing code conversion information; and
a URN code conversion unit for creating a URN code by converting substantial information of the EPC separated based on code conversion information into the URN code.

9. The ontology-based EPC automatic conversion apparatus as set forth in claim 7, wherein the ontology classes comprise an EPC class, a Code class, a Class class, an Additional class, a Body class, a Fragment class and a Partition class.

10. The ontology-based EPC automatic conversion apparatus as set forth in claim 9, wherein the EPC class divides subClassof according to class relation, and the Additional class, Class class, Body class, Fragment class and Partition class comprise hasAdditional, hasClass, hasBody, hasFragment and hasPartition, respectively, as their object properties.

11. The ontology-based EPC automatic conversion apparatus as set forth in claim 9, wherein:
the Additional class comprises CodeName, CodeMember, CodeSize and CodeURN as its data type properties;
the Class class comprises CodeHeader and CodeEncode as its data type properties;
the Body class comprises BodyCount, PartitionCount and WordBoundary as its data type properties;
the Fragment class comprises FragmentName, FragmentProcess, StartLocation and EndLocation as its data type properties; and
the Partition class comprises Value, FirstBit and SecondBit as its property data type properties.
